(19) United States
(12) Patent Application Publication
(10) Pub. No.: US 2026/0208237 A1
(43) Pub. Date: Jul. 23, 2026

(54) FOREIGN SUBSTANCE REMOVING DEVICE FOR SHEET MATERIAL, SHEET MATERIAL MANUFACTURING DEVICE, AND SHEET MATERIAL MANUFACTURING METHOD

(71) Applicant: Toray Industries, Inc., Chuo-ku, Tokyo (JP)

(72) Inventors: Kentaro NAGASAKI, Otsu-shi, Shiga (JP); Tamotsu SUZUKI, Otsu-shi, Shiga (JP); Yu TERAMOTO, Shiga (JP); Koji YAMANO, Anpachi-gun, Gifu (JP)

(73) Assignee: Toray Industries, Inc., Chuo-ku, Tokyo (JP)

(21) Appl. No.: 19/157,865

(22) PCT Filed: Feb. 15, 2024
(86) PCT No.: PCT/JP2024/005323

§ 371 Date: Aug. 19, 2025

(30) Foreign Application Priority Data
Mar. 7, 2023 (JP) 2023-034339

(51) Int. Cl. B08B 5/02

(52) U.S. Cl. CPC B08B 5/026; B08B 2205/00

(57) ABSTRACT

A foreign substance removing device for a sheet material includes a gas injection mechanism disposed away from a surface of a sheet material from which a foreign substance is to be removed, the foreign substance removing device removing the foreign substance by injecting gas toward the sheet material from the gas injection mechanism. The gas injection mechanism includes an injection hole unit including a pair of a first injection hole and a second injection hole, each of which injects the gas toward the surface of the sheet material, and in a cross section including central axes of the first injection hole and the second injection hole, extended lines of inner ridgelines of the first injection hole and the second injection hole are inclined so as to intersect with each other at a position away from the surface of the sheet material toward the gas injection mechanism.

### CROSS REFERENCE TO RELATED APPLICATIONS

This application is the U.S. National Phase of PCT/JP2024/005323, filed Feb. 15, 2024, which claims priority to Japanese Patent Application No. 2023-034339, filed Mar. 7, 2023, the disclosures of each of these applications being incorporated herein by reference in their entireties for all purposes.

### FIELD OF THE INVENTION

The present invention relates to a foreign substance removing device for a sheet material, a sheet material manufacturing device, and a sheet material manufacturing method for removing foreign substances from the sheet material by injecting gas toward the sheet material being conveyed.

### BACKGROUND OF THE INVENTION

In a sheet material such as a plastic film, a glass film, fabric, and nonwoven fabric, foreign substances, such as dirt, dust, and fluff, adhering to/generated on the surface layer of the sheet material may deteriorate the function of the sheet material. Although, ideally, such foreign substances are prevented from being generated in a process of manufacturing a sheet-shaped base material, this may be practically difficult. In such a case, these foreign substances need to be removed afterward by some method.

A method of blowing gas onto the surface of a sheet material and simultaneously suctioning gas has been proposed as a device of removing foreign substances from the sheet material. (Patent Literature 1)

Moreover, a device of creating a turbulent flow region has been disclosed as a powerful method of removing foreign substances. The device creates the turbulent flow region by injecting pieces of ultrasonic air from the upstream direction and the downstream direction of a sheet material being conveyed, causing the pieces of ultrasonic air to collide with the sheet material, and then causing the pieces of ultrasonic air to join together on the surface of the sheet material. (Patent Literature 2)

Furthermore, a method of suctioning the surface of a sheet material and brushing the surface of the sheet material with a brush has been proposed as a method of directly removing foreign substances in addition to a method of indirectly removing foreign substances by air as described above. (Patent Literature 3)

### PATENT LITERATURE

Patent Literature 1: JP H5-138136 A
Patent Literature 2: JP H7-60211 A
Patent Literature 3: JP 2008-34295 A

### SUMMARY OF THE INVENTION

Only foreign substances adhering to the surface of a sheet material, however, can be removed by the method in Patent Literature 1. The method does not have energy for removing foreign substances entangled from the surface to the inside of a sheet material such as nonwoven fabric and fabric. Furthermore, the device in Patent Literature 2 cannot increase the density of an energy region generated by collision between pieces of air, and may fail to remove firmly bound foreign substances. Moreover, although the method in Patent Literature 3 can be applied to a sheet material made of an indestructible material with a certain degree of rigidity, the method may damage a thin film and a thin glass substrate, and scratch the surfaces thereof. In addition, since high suction force is necessary for collecting removed foreign substances, the sheet material itself is highly likely to be auctioned and broken.

In view of the above-described circumstances, the present invention provides a foreign substance removing device for a sheet material, a sheet material manufacturing device, and a sheet material manufacturing method, which can remove various foreign substances firmly adhering to the sheet material.

### Solution to Problem

[1] The present invention to solve the problem is a foreign substance removing device for a sheet material, including a gas injection mechanism disposed away from a surface of a sheet material from which a foreign substance is to be removed, the foreign substance removing device removing the foreign substance by injecting gas toward the sheet material from the gas injection mechanism. The gas injection mechanism includes an injection hole unit including a pair of a first injection hole and a second injection hole, each of which injects the gas toward the surface of the sheet material, and in a cross section including central axes of the first injection hole and the second injection hole, extended lines of inner ridgelines of the first injection hole and the second injection hole are inclined so as to intersect with each other at a position away from the surface of the sheet material toward the gas injection mechanism.

The foreign substance removing device according to the present invention is preferably in any one of the following [2] to [7] embodiments.

[2] The foreign substance removing device for a sheet material, according to [1], wherein in the cross section including the central axes of the first injection hole and the second injection hole, the first injection hole and the second injection hole are inclined such that extended lines of outer ridgelines of the first injection hole and the second injection hole intersect with each other either on the surface of the sheet material or at a position away from the surface of the sheet material toward the gas injection mechanism.

[3] The foreign substance removing device for a sheet material, according to [1] or [2], wherein in the cross section including the central axes of the first injection hole and the second injection hole, the central axes of the first injection hole and the second injection hole are inclined so as to intersect with each other at an angle of 60° to 150°.

[4] The foreign substance removing device for a sheet material, according to any one of [1] to [3], wherein the gas injection mechanism is disposed such that an outlet of each of the first injection hole and the second injection hole is located at a position 0.5 mm to 20.0 mm away from the surface of the sheet material.

[5] The foreign substance removing device for a sheet material, according to any one of [1] to [4], wherein an outlet of each of the first injection hole and the second injection hole has an opening diameter of 0.5 mm to 5.0 mm.

[6] The foreign substance removing device for a sheet material, according to any one of [1] to [5], further including a swing mechanism configured to reciprocate the gas injection mechanism in a width direction of the sheet material.

[7] The foreign substance removing device for a sheet material, according to [6], wherein the gas injection mechanism includes a plurality of injection hole units arranged in the width direction of the sheet material, and a movement distance of the swing mechanism in a width direction of the gas injection mechanism is twice or more an arrangement interval between the injection hole units.

[8] A sheet material manufacturing device, comprising the foreign substance removing device for a sheet material, according to any one of [1] to [7].

[9] A sheet material manufacturing method, including a step of removing a foreign substance by using the foreign substance removing device for a sheet material, according to any one of [1] to [7].

Note that, in the present invention, a “sheet material” is used as a generic term for continuously conveyed and manufactured materials having sheet shapes, such as a plastic film, a glass film, fabric, and nonwoven fabric.

According to the present invention, various foreign substances firmly adhering to a sheet material can be removed.

### BRIEF DESCRIPTION OF THE DRAWINGS

FIG. 1 is a schematic perspective view of an embodiment of a foreign substance removing device for a sheet material of the present invention.

FIG. 2 is an enlarged cross-sectional view of a gas injection mechanism of the foreign substance removing device for a sheet material in FIG. 1.

FIG. 3 is a schematic cross-sectional view of the embodiment of the foreign substance removing device for a sheet material of the present invention.

FIG. 4 is an enlarged cross-sectional view of a gas injection mechanism of another embodiment of the present invention.

FIG. 5 illustrates a movement distance of a swing mechanism in the width direction of the gas injection mechanism.

### DETAILED DESCRIPTION OF EMBODIMENTS OF THE INVENTION

Although a case where a foreign substance removing device for a sheet material according to embodiments of the present invention is used to remove wood powder from a sanding belt will be described below with reference to the drawings by using the sanding belt as an example of a sheet material, the present invention is not limited at all by the embodiments described with reference to the drawings. Furthermore, the description of a specific embodiment given with reference to the drawings can also be understood as a description of the present invention as a superordinate concept.

The sanding belt refers to pieces of sandpaper connected in a belt shape. The sanding belt is attached to a belt sander, which enables the surface of an object to be continuously polished, Sanding belts for woodworking, ironworking, stone, and the like can be selected depending on the object. In general, when a surface of wood or the like is continuously polished with a sanding belt, the surface of the sanding belt is clogged with wood powder. This deteriorates polishing performance, and causes polishing failure. Thus, replacement of the sanding belt is necessary after use for a certain period of time. In order to efficiently and continuously polish a surface, wood powder can be desirably removed simultaneously with polishing.

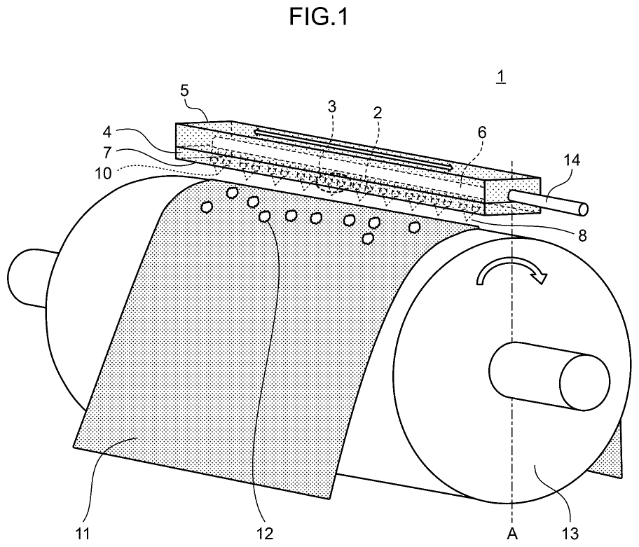

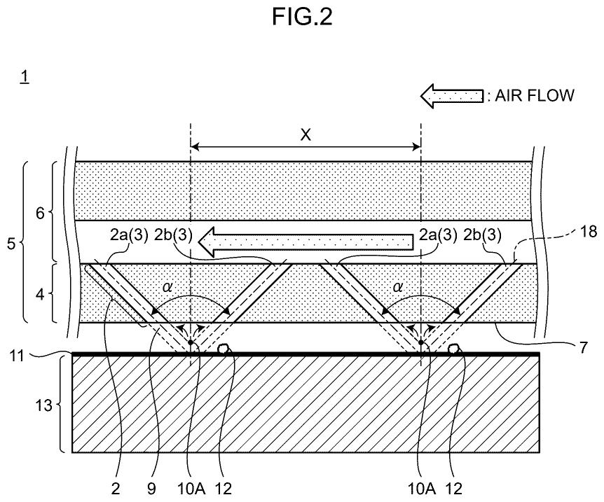

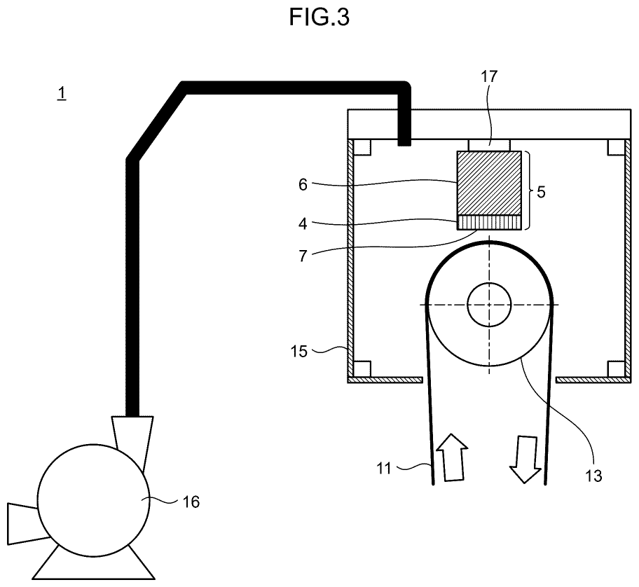

FIG. 1 is a schematic perspective view of a foreign substance removing device 1 for a sheet material according to an embodiment of the present invention. The foreign substance removing device 1 is used to remove foreign substances, mainly wood powder 12, from a sanding belt 11 attached to a large belt sander. Furthermore, FIG. 2 is a cross-sectional schematic view of a gas injection mechanism 5 of the embodiment in FIG. 1. Furthermore, FIG. 3 is a schematic cross-sectional view of the foreign substance removing device according to the embodiment of the present invention. The foreign substance removing device 1 includes a joint portion (not illustrated) for the sanding belt 11, and is installed in a part of a conveying path in a conveying device that conveys the sanding belt 11 with the large belt sander.

The foreign substance removing device 1 includes the gas injection mechanism 5 and a bending roll 13. The gas injection mechanism 5 injects gas to the sanding belt 11. The bending roll 13 conveys the sanding belt 11. Then, the bending roll 13 is provided at a position facing an injection surface 7 of the gas injection mechanism 5 with the passage surface of the sanding belt 11 interposed therebetween. Note that, in the following description, a state in which the sanding belt 11 passes through the foreign substance removing device 1 is assumed. The passage surface of the sanding belt 11 may be simply referred to as the “sanding belt 11”.

The gas injection mechanism 5 includes a chamber 6 and a plate 4. The chamber 6 is space for taking in injected gas. The plate 4 is provided in the chamber 6 on the passage surface side of the sanding belt 11. The plate 4 has injection holes 2 for injecting gas to the sanding belt 11 while being connected to a gas supply path 14 for supplying gas to the chamber 6.

The injection holes 2 are through holes penetrating from the inner surface of the plate 4 to the injection surface 7 at an angle with respect to the vertical direction. The injection surface 7 is an outer surface facing the sanding belt 11 of the plate 4.

Although the overall shapes of the injection holes 2 are not particularly limited, the injection holes 2 preferably have a substantially cylindrical shape that does not cause pressure loss and does not disturb a jet flow. Furthermore, although the injection holes 2 may have various circular cross-sectional shapes such as a perfect circle and an ellipse on a plane perpendicular to the center lines of the injection holes 2, the injection holes 2 most preferably have a cross-sectional shape of a perfect circle. Although the injection holes 2 may have a cross-sectional shape of a slit, the injection holes 2 preferably have a circular cross-sectional shape. This is because the alit shape increases opening areas of the injection holes 2 to decrease the flow velocity of air even with the same air supply amount and a large amount of air is needed. Optimum values of the diameters of inscribed circles of the openings on the injection surface 7 of the injection holes 2 are appropriately determined by the distance between a target sheet material and the injection surface 7. When foreign substances are removed from the sanding belt 11, the diameters preferably fall within a range of 0.5 to 5.0 mm.

In order to remove the wood powder 12 adhering to the surface and gaps between abrasive grains of the sanding belt 11, the wood powder 12 needs to be vibrated by forming a high energy region 9 by causing jet flows from the injection holes 2 to collide with each other. Thus, the gas injection mechanism 5 in the present invention includes at least two injection holes 2. Then, the two injection holes 2 are defined as a first injection hole 2a and a second injection hole 2b. A point where a jet flow from the first injection hole 2a first collides with a jet flow from the second injection hole 2b is defined as a collision point 10A. The first injection hole 2a and the second injection hole 2b are configured such that the collision point 10A is located away from the surface of the sanding belt 11, which is conveyed, toward the injection surface 7 of the gas injection mechanism 5. Specifically, as illustrated in FIG. 2, the collision point 10A of the two jet flows is a point where virtual regions first intersect with each other. The virtual regions are obtained by linearly extending, toward the sanding belt 11, three-dimensional shapes (when injection holes have circular cross section, cylindrical shape) specified by the inner cavities of the first injection hole 2a and the second injection hole 2b. The first injection hole 2a and the second injection hole 2b are designed such that the collision point 10A is located away from the surface of the sanding belt 11 toward the injection surface 7. In other words, FIG. 2 is a cross-sectional view on a plane including a central axis 18 of the first injection hole 2a and a central axis 18 of the second injection hole 2b. In the cross section, a point where an extended line of am inner ridgeline of the first injection hole 2a intersects with an extended line of an inner ridgeline of the second injection hole 2b is defined as the collision point 104. The first injection hole 2a and the second injection hole 2b are inclined such that the collision point 10A is located away from the surface of the sanding belt 11 toward the injection surface 7 of the gas injection mechanism 5. In order to efficiently remove the wood powder 12 adhering to the sanding belt 11, the wood powder 12 is preferably exposed in the high energy region 9 obtained by causing jet flows from the injection holes 2 to collide with each other. Thus, the high energy region 9 is preferably generated reliably on the surface of the sanding belt 11.

Note that, in the present specification, the pair of the first injection hole Za and the second injection hole 2b configured as described above form one injection hole unit 3.

Furthermore, as illustrated in FIG. 2, an angle at which the central axis 18 of the first injection hole 2a intersects with the central axis 18 of the second injection hole 2b is defined as α in the cross section on the plane including the central axis 18 of the first injection hole 2a and the central axis 18 of the second injection hole 2b. The angle α preferably falls within a range of 60° to 150°. The range enables formation of the high energy region 9 having extremely high energy. An angle of 60° or more increases energy of collision between jet flows from the two injection holes 2, facilitates formation of the high energy region 9, and enhances removal performance. An angle of 150° or less causes the high energy region 9 to be formed at a position that is not close to the injection surface 7. The sanding belt 11 and the injection surface 7 can thus be separated from each other. The injection holes 2 formed on the injection surface 7 are not easily clogged with the wood powder 12. The upper limit of the angle α is more preferably 120° or less. The angle α of 120° or less can reduce the width of one injection hole unit 3. As will be described later, a plurality of injection hole units 3 can be arranged to process a larger area.

Note that, although the injection holes 2 are opened to the injection surface 7 of the plate 4 in the embodiment, this is not a limitation. The injection holes 2 may be nozzles that protrude from the injection surface 7 and open.

A part of the two jet flows 8 that have collided first at the collision point 10A tries to return toward of the injection surface 7 by repulsive force. The part of the repulsive jet flows 8 is guided again to the vicinity of the openings of the injection holes 2, and intersects with jet flows 8 injected later. Such collision and intersection of jet flows can form the high energy region 9 where complicated turbulent flows exist.

Furthermore, in the embodiment, the distance between the outlets of the two injection holes 2 (first injection hole 2a and second injection hole 2b) and the sanding belt 11 is preferably 0.5 to 20.0 mm, and more preferably 0.9 to 5 mm. A range of 0.5 to 20 mm can form the high energy region 9 having extremely high energy, and inhibit the injection holes 2 from being clogged with the wood powder 12.

Furthermore, in the embodiment of the present invention, the outlets of the first injection hole Za and the second injection hole 2b preferably have opening diameters of 0.5 to 5.0 mm. The range enables formation of jet flows in an appropriate air flow rate. An opening diameter of 0.5 mm or more can make the high energy region 9 to be formed larger than the wood powder 12, so that the wood powder 12 can be reliably processed. Furthermore, a small opening diameter increases flow path pressure loss, and a supply pressure of a supply source of jet flows thus needs to be increased, which makes a device expensive. An opening diameter of 5.0 mm or less can reliably form the high energy region 9 necessary for processing the wood powder 12, and inhibit the consumption flow rate of jet flows to be consumed, which leads to good energy efficiency.

Since the sanding belt 11 generally has a length of 300 mm or more in the width direction, a plurality of injection hole units 3 is preferably provided in the plate 4 in accordance with the width direction of the sanding belt 11. In this case, the injection hole units 3 are preferably arranged at equal distances. Although an arrangement interval X between adjacent injection hole units 3 can be appropriately selected in accordance with the opening diameters of the injection holes 2, the arrangement interval X is preferably 5 to 50 mm, and more preferably 5 to 30 mm. As illustrated in FIG. 2, the arrangement interval X between the adjacent injection hole units 3 is the distance between central axes of the adjacent injection hole units 3. An axis passing through the collision point 10A of the jet flows 8 from the two injection holes 2 of the injection hole unit 3 is defined as a central axis of the injection hole unit 3. An arrangement interval of 5 mm or more can remove the wood powder 12 in an aimed range without an influence of the high energy region 9 formed by the adjacent injection hole units 3. Furthermore, an arrangement interval of 50 mm or less can efficiently remove every wood powder 12 of the sanding belt 11 in a wide range simultaneously.

A plurality of injection hole units 3 is arranged in one line in the width direction of the sanding belt 11, but a plurality of lines of injection hole units 3 may be arranged in a conveyance direction of the sanding belt 11. Moreover, in this case, the injection hole units 3 may be arranged so as to be shifted in the width direction for each line. This enables every wood powder to be removed by one piece of processing. Moreover, this can reduce an area processed by one set of injection hole units 3, and increase a processing area per unit time.

The gas injection mechanism 5 preferably has a configuration in which the plate 4 having the injection holes 2 is detachably attached to the chamber 6 as illustrated in FIG. 1. The detachable plate 4 having the injection holes 2 can easily address a case where the injection holes 2 are damaged or a case where the width of the sanding belt 11 to be processed changes only by replacing the plate 4.

Furthermore, as illustrated in FIG. 3, the gas injection mechanism 5 is preferably fixed to a swing mechanism 17 so as to swing in the width direction of the sanding belt 11. Swinging the gas injection mechanism 5 in the width direction causes the high energy region 9 generated by the injection hole unit 3 to move so as to scan the surface of the sanding belt 11 in the width direction, so that an area that can be processed by one injection hole unit 3 can be increased. This enables the entire surface of the sanding belt 11 to be processed without increasing the number of the injection hole units 3. Although, when the gas injection mechanism 5 is swung, the frequency can be determined by the conveyance speed of the sanding belt 11, the arrangement interval of the injection hole units 3, and the distance of the swing of the gas injection mechanism 5, the gas injection mechanism 5 swings preferably at a frequency of 1 to 30 Hz, and more preferably at 5 to 20 Hz.

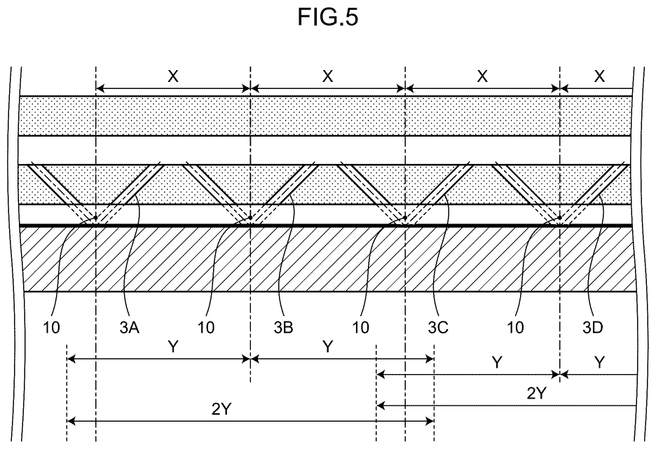

A movement distance of the swing of the gas injection mechanism 5 will be described with reference to FIG. 5. Injection hole units 3A, 3B, 3C, and 3D are arranged adjacent to each other at the arrangement interval X. The gas injection mechanism 5 repeatedly swings. When attention is paid to the injection hole unit 3B, the injection hole unit 3B moves toward the injection hole unit 3A by a distance Y, and returns to the original position again. Subsequently, the injection hole unit 38 moves toward the injection hole unit 3C by the distance Y, and returns to the original position again. The distance Y is preferably equal to or larger than the arrangement interval X, and more preferably 1.4X≤Y≤1.6X so that a defect of one injection hole unit 3 can be compensated for by injection hole units 3 on both sides of the injection hole unit 3. The distance Y equal to or larger than the arrangement interval X enables the injection hole unit 3B and the injection hole unit 3D to compensate for a region where the injection hole unit 3C swings and injects gas even if the injection hole unit 3C has a defect and cannot inject a jet flow. The distance Y 1.4 times or more the arrangement interval X can reliably compensate for the region where the injection hole unit 3C swings, and can keep an effect of removing foreign substances such as the wood powder 12. Furthermore, the distance Y 1.6 times or less the arrangement interval X prevents a swing mechanism from becoming too large, and can avoid an increase in size of the device itself and an increase in cost of the device.

When the above is described by a reciprocating movement of the entire gas injection mechanism 5, the gas injection mechanism 5 moves by a distance 2Y in the first half path, and moves by a distance 2Y in the last half path. Therefore, the movement distance 2Y in the first half path and the last half path of the gas injection mechanism 5 is preferably twice or more the arrangement interval X, and more preferably 1.4·2X≤2Y≤1.6·2X.

Gas used as the jet flows 8 is preferably air, and more preferably compressed air. The flow rates of the jet flows 8 are preferably 10 NL/min to 50 NL/min per set of injection hole units 3.

Although, in the embodiment, the bending roll 13 can be incorporated in a part of a conveying system of the foreign substance removing device 1, the bending roll 13 constitutes a part of the foreign substance removing device 1 in the present invention. The bending roll 13 is installed to bend the sanding belt 11 in an arc shape such that the gas injection mechanism 5 is located on the obtuse angle side at the time when the sanding belt 11 passes through the gas injection mechanism 5. When the sanding belt 11 is held by the bending roll 13, external force is applied to the wood powder 12 contained in gaps between abrasive grains of the sanding belt 11 to release the binding and cause the wood powder 12 to easily come out.

The bending roll 13 preferably has a diameter of 100 to 500 mm. The bending roll 13 having too small a diameter excessively bends the sanding belt 11, which may lead to fracture depending on the type of sandpaper. In contrast, the bending roll 13 having too large a diameter prevents the wood powder 12 from protruding. The bending roll 13 more preferably has a diameter of 130 to 230 mm.

The bending roll 13 preferably has a width larger than the width of the sanding belt 11 since such a bending roll 13 can prevent the sanding belt 11 from being bent or flapping at the time when the jet flows 8 collide with each other.

The bending roll 13 is preferably made of metal material. When the bending roll 13 is used, the injection hole unit 3 is preferably arranged on the same straight line as a line A (see FIG. 1) passing through the collision point 10A of the jet flows 8 and the center of the bending roll 13.

Note that a auction mechanism preferably collects the removed wood powder 12. If the gas injection mechanism 5 merely blows the wood powder 12, the wood powder 12 flies back onto the sanding belt 11 again depending on an air flow, which reduces an effect of removal. In a preferred mode of preventing the removed wood powder 12 from being scattered around the device, as illustrated in FIG. 3, a processing surface of the sanding belt 11 supported by the gas injection mechanism 5 and the bending roll 13 is disposed in a processing box 15, and a negative pressure is created inside the processing box by connecting a suction mechanism 16 to the processing box 15. In the mode, cleaning of the processing box 15 is unnecessary, and processing of removing the wood powder 12 can be continuously performed.

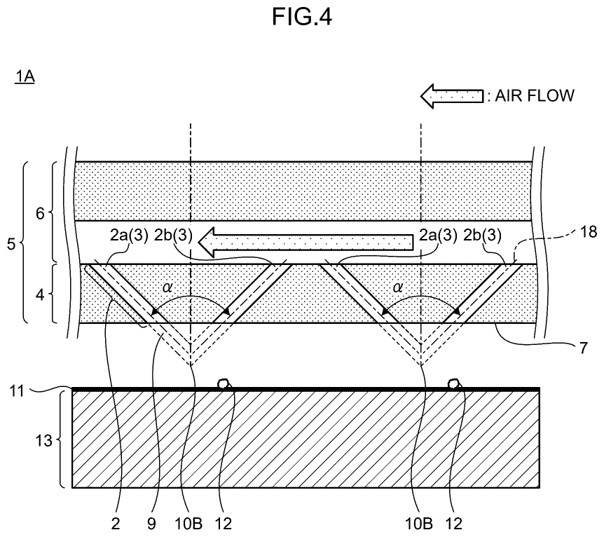

FIG. 4 is an enlarged cross-sectional view of a gas injection mechanism in another embodiment of the foreign substance removing device of the present invention. In a foreign substance removing device 1A in FIG. 4, the first injection hole 2a and the second injection hole 2b are provided such that a point 10B is located on the surface of the sanding belt 11 or is located away from the surface of the sanding belt 11 toward the gas injection mechanism 5. At the point 10B, an extended line of an outer ridgeline of the first injection hole 2a intersects with an extended line of an outer ridgeline of the second injection hole 2b in a cross section including the central axis 18 of the first injection hole 2a and the central axis 18 of the second injection hole 2b. Energy for removal is retained between the high energy region 9 and the sanding belt 11 although the removal performance deteriorates as compared to that of the high energy region 9 and energy attenuates as the distance from the injection surface 7 increases. Therefore, the configuration as described above can prevent the sanding belt 11 from coming in contact with the injection surface 7 at the time when the sanding belt 11 swings in the direction of the injection surface 7 due to vibration or abnormality of the device, and protect the injection surface 7 and the circular cross-sectional shapes of the injection holes 2 although the distance between the injection surface 7 and the sanding belt 11 increases and the capability to remove the wood powder 12 deteriorates. If the sanding belt 11 comes in contact with the injection surface 7 to damage the circular cross sections of the injection holes 2, the flow velocities of the jet flows 8 may decrease, or the central axis 18 of the first injection hole 2a and the central axis 18 of the second injection hole 2b may deviate to prevent collision between the jet flows. In such a case, the high energy region 9 cannot be obtained, and the wood powder 12 cannot be removed. Moreover, replacement of the injection surface 7 or the gas injection mechanism 5 is required, which causes waste of time and money. Thus, in a preferred mode, the injection surface 7 and the sanding belt 11 are installed at a certain distance.

### EXAMPLES

The present invention will be described in more detail below with reference to examples. The scope of the present invention is, however, not limited to the examples;

### Example 1

Black sandpaper having a grit size of 320 was used as a sanding belt. The sanding belt has a loop shape, and has a width of 1000 mm. The sanding belt was hung on two bending rolls of φ200 mm separated by a distance of 1200 mm. A motor directly connected to a drive shaft of the bending rolls rotated the bending rolls. The sanding belt was conveyed at a speed of 500 m/min. In the case, the bending rolls have position adjustment mechanisms in directions in which the distance therebetween increases. The position adjustment mechanisms apply tension to the sanding belt to prevent the sanding belt from loosening. Wood having a width of 900 mm and a length of 5000 mm was caused to approach the top of one of the two bending rolls. The wood was fed at a speed of 1 m/min. The surface of the wood was continuously polished. This caused wood powder generated by the polishing to adhere to the surface and gaps between abrasive grains of the sanding belt. In the case, a gas injection mechanism was installed toward the top of the other bending roll. The gas injection mechanism had a width length of 1100 mm such that the centers were aligned in the width direction of the sanding belt. The first injection hole and the second injection hole were provided such that the gas injection mechanism had injection holes having a circular diameter of φ1.0 mm, am angle formed by the central axis of the first injection hole and the central axis of the second injection hole was 90°, an extended line of an inner ridgeline of the first injection hole intersected with an extended line of an inner ridgeline of the second injection hole at a position 3 mm away from the surface of the injection surface, and an extended line of an outer ridgeline of the first injection hole intersected with an extended line of an outer ridgeline of the second injection hole at a position 4.4 mm away from the surface of the injection surface. Furthermore, the first injection hole and the second injection hole have openings such that the openings are aligned in one line in the width direction of the gas injection mechanism. A pair of injection hole units was installed such that a collision point of jet flows from the two injection holes had a pitch of 16 mm. Here, 69 sets of injection hole units were installed. The distance of the sanding belt from the injection surface was set to 4 mm. A flow rate of 50 NL/min from the pair of injection hole units was set. In this state, a swing width of 24 mm and a swing frequency of 15 Hz were set via a swing mechanism. The periphery of the gas injection mechanism was covered with a cover. A hose connected from a blower was attached to the cover. Wood powder removed by the gas injection mechanism was collected.

Wood powder adhering to the sanding belt whitens the sanding belt. When the gas injection mechanism performs foreign substance removing processing, the sandpaper returns to original black, so that a series of effects can be confirmed. The gas injection mechanism injected air to remove wood pieces. The surface of the sanding belt was observed by using a digital microscope at 200 times at a total of 70 places of 14 places at equal intervals of 100 mm in a machine length direction and five places at equal intervals of 100 mm in a machine width direction. As a result, all the wood powder was removed. One piece of wood powder remained. The original abrasive grains of the sandpaper were confirmed. Here, zero pieces of wood powder remaining on the sanding belt were determined as indicating excellent removal performance. One or more and 10 or less pieces of remaining wood powder were determined as indicating excellent removal performance. Furthermore, 11 to 49 pieces of remaining wood powder were determined as indicating good removal performance, and 50 or more pieces of remaining wood powder were determined as indicating poor removal performance.

### Example 2

Processing of removing wood powder on the sanding belt was performed by using the same conditions as those in Example 1 except that the distance of the sanding belt from the injection surface was changed to 6 mm. The surface of the sanding belt after removing wood piece in a method similar to that in Example 1 was observed. As a result, eight pieces of wood powder remained, which indicated good removal performance.

### Comparative Example 1

Processing of removing wood powder on the sanding belt was performed by using the same conditions as those in Example 1 except that the first injection hole and the second injection hole were provided such that an extended line of the inner ridgeline of the first injection hole intersected with an extended lime of the inner ridgeline of the second injection hole at a position 5 mm away from the surface of the injection surface. The surface of the sanding belt after removing wood piece in a method similar to that in Example 1 was observed. As a result, wood powder was not removed, and 74 pieces of wood powder remained, which indicated poor removal performance.

Table 1 collects the results of Examples 1 and 2 and Comparative Example 1.

TABLE 1

| | | | Comparative |
|---|---|---|---|
| | Example 1 | Example 2 | Example 1 |
| Distance (mm) between intersection | 3 | 3 | 5 |
| of extended lines of inner ridgelines | | | |
| and injection surface | | | |
| Distance (mm) between intersection | 4.4 | 4.4 | 6.4 |
| of extended lines of outer ridgelines | | | |
| and injection surface | | | |
| Distance (mm) between injection | 4 | 6 | 4 |
| surface and sanding belt | | | |
| Number of wood power remaining on | 1 | 8 | 74 |
| sanding belt | | | |

### REFERENCE SIGNS LIST

1 FOREIGN SUBSTANCE REMOVING DEVICE
2, 2a, 2b INJECTION HOLE
3 INJECTION HOLE UNIT
4 PLATE
5 GAS INJECTION MECHANISM
6 CHAMBER
7 INJECTION SURFACE
8 JET FLOW
9 HIGH ENERGY REGION
10A, 10B COLLISION POINT
11 SANDING BELT
12 WOOD POWDER
13 BENDING ROLL
14. GAS SUPPLY PATH
15 PROCESSING BOX
16 SUCTION MECHANISM
17 SWING MECHANISM
18 CENTRAL AXIS
X ARRANGEMENT INTERVAL BETWEEN ADJACENT INJECTION HOLE UNITS
Y HALF OF MOVEMENT AMOUNT OF FIRST HALF PATH AND LAST HALF PATH OF GAS INJECTION MECHANISM

1. A foreign substance removing device for a sheet material, comprising a gas injection mechanism disposed away from a surface of a sheet material from which a foreign substance is to be removed, the foreign substance removing device removing the foreign substance by injecting gas toward the sheet material from the gas injection mechanism,
wherein the gas injection mechanism includes an injection hole unit including a pair of a first injection hole and a second injection hole, each of which injects the gas toward the surface of the sheet material, and
in a cross section including central axes of the first injection hole and the second injection hole, extended lines of inner ridgelines of the first injection hole and the second injection hole are inclined so as to intersect with each other at a position away from the surface of the sheet material toward the gas injection mechanism.

2. The foreign substance removing device for a sheet material, according to claim 1, wherein in the cross section including the central axes of the first injection hole and the second injection hole, the first injection hole and the second injection hole are inclined such that extended lines of outer ridgelines of the first injection hole and the second injection hole intersect with each other either on the surface of the sheet material or at a position away from the surface of the sheet material toward the gas injection mechanism.

3. The foreign substance removing device for a sheet material, according to claim 1, wherein in the cross section including the central axes of the first injection hole and the second injection hole, the central axes of the first injection hole and the second injection hole are inclined so as to intersect with each other at an angle of 60° to 150°.

4. The foreign substance removing device for a sheet material, according to claim 1, wherein the gas injection mechanism is disposed such that an outlet of each of the first injection hole and the second injection hole is located at a position 0.5 mm to 20.0 mm away from the surface of the sheet material.

5. The foreign substance removing device for a sheet material, according to claim 1, wherein an outlet of each of the first injection hole and the second injection hole has an opening diameter of 0.5 mm to 5.0 mm.

6. The foreign substance removing device for a sheet material, according to claim 1, further comprising a swing mechanism configured to reciprocate the gas injection mechanism in a width direction of the sheet material.

7. The foreign substance removing device for a sheet material, according to claim 6,
wherein the gas injection mechanism includes a plurality of injection hole units arranged in the width direction of the sheet material, and
a movement distance of the swing mechanism in a width direction of the gas injection mechanism is twice or more an arrangement interval between the injection hole units.

8. A sheet material manufacturing device, comprising the foreign substance removing device for a sheet material, according to claim 1.

9. A sheet material manufacturing method, comprising a step of removing a foreign substance by using the foreign substance removing device for a sheet material, according to claim 1.
